(19) United States
(12) Patent Application Publication
(10) Pub. No.: US 2014/0108291 A1
(43) Pub. Date: Apr. 17, 2014

(54) Funding Loans Through the Short Sale of Yield Bearing Assets

(71) Applicant: GREGORY IVAN SAWCHYN, Upper Arlington, OH (US)

(72) Inventor: GREGORY IVAN SAWCHYN, Upper Arlington, OH (US)

(21) Appl. No.: 13/649,666

(22) Filed: Oct. 11, 2012

(51) Int. Cl. G06Q 40/06

(52) U.S. Cl. CPC G06Q 40/06
USPC 705/36 R

(57) ABSTRACT

A system and method are provided for funding loans. The method includes selling US Treasury securities (or other yield bearing assets) short and using the proceeds of the short sale to fund a loan to a borrower. The system includes a feature to aggregate and database securities available to sell short along with pertinent information about those securities. The system compares a proposed loan's cash flows to the cash flows of securities available to sell short. The system uses cash flow matching algorithms to construct a portfolio of securities to sell short to fund a loan. The system had the ability to effect the execution of transactions to sell securities short once included in a portfolio of securities to fund a loan. An option allows for multiple loans to be aggregated for the purpose of cash flow matching with securities to sell short.

### CROSS-REFERENCE TO RELATED APPLICATIONS

This application claims the benefit of U.S. Provisional Application No. 61/627,350, filed Oct. 11, 2011.

### BACKGROUND OF THE INVENTION

1. Field of the Invention

The present invention relates to a computer implemented process of funding loans through selling U.S. Treasury securities (or other yield bearing assets) short to decrease servicing costs for borrowers and providing low-cost funds to lenders.

2. Background

Currently, there are a number of solutions for commercial loans, commercial real estate mortgages, and residential mortgages. Some of these solutions attempt to provide a win-win to both borrowers and lenders, but these solutions fail to meet the needs of the industry because they require significant capital balances for lenders and high underwriting and collateral requirements that many borrowers cannot meet. Some current mortgage options are originated under the rules of the GSE's (Government Sponsored Enterprises such as Fannie Mae, Freddie Mac, etc)—said GSE's are currently under government receivership and it is likely they will wind down operations or significantly change their operations and disrupt current mortgage markets. Indications are that regulators want lenders to be more responsible for performance of their loans and to provide at least a portion of the capital required to fund loans from dwindling capital resources available from traditional lenders such as banks. Additionally, there is a spread that is passed through from the GSE's to the originator that does not allow the lowest possible rate. Additionally, the GSE's impose various restrictions such as: the type of product that can be offered, the collateral required, and the terms of that product.

The present invention is relevant for various types of loans including, but not limited to, purchase money mortgages, home refinancing, commercial real estate transactions, and business loans. Few refinancing options remain available to a homeowner, when a homeowner is currently underwater or otherwise unqualified for a standard GSE product. The present invention allows a homeowner, or other borrower, to effectively refinance all or part of their mortgage/loan without necessarily exposing the lender to additional risk because the overall amount of debt would in most cases stay constant, but the effective terms for the borrower can be significantly improved.

GSE's place limits on the amount that can be funded. Loans above this amount are deemed Jumbo loans in the residential market and require private funding. The invention provides an efficient mechanism to provide such private funding.

Currently, companies and individuals can deduct interest paid on many types of loans, including mortgages. It can make sense for an entity or individual with significant assets to pledge other assets as collateral for loan rather than the asset the loan is being used to purchase. This is not possible under current GSE rules.

Lenders, such as banks, utilize various methods to fund loans like: deposits, certificates of deposits, common equity, debt instruments, etc. The present invention adds another potential funding source to a bank's repertoire.

Interest rate swaps are another product offered by financial institutions to hedge interest rate risk. A disadvantage of interest rate swaps are that these derivative products are negotiated on a case by case basis and usually only available on large loans due to the need for individual negotiation for items such as term, collateral, rate, etc. The present invention presents a standardized method to recreate similar cash flow profiles to swaps more efficiently, thus allowing the benefits of interest rate swaps to a wider range of borrowers.

The present invention addresses the need for mortgage or other loan borrowers to hedge interest rate risk of loans and for banks and lenders to potentially make payments more affordable, increase their collateral position, and do so without materially increasing risk of an existing loan. The present invention also addresses need for mortgage originators to continue to offer mortgages at attractive rates if the GSE's were to curtail purchases, wind down operations, or otherwise make their products less attractive.

The present invention allows banks to offer borrowers lower payments. These lower payments will enable under-water borrowers to avoid default and in the case of a mortgage borrower, to stay in a home while also preventing banks from having to foreclose or maintain a property in “shadow” foreclosure. Foreclosing is an expensive proposition for banks and often leads to further losses. The present invention allows lenders, such as banks, to reap profits and borrowers to obtain lower monthly payments.

### BRIEF SUMMARY OF THE INVENTION

The present invention is a computer implemented process that advantageously fills the aforementioned deficiencies by providing lending/borrowing at low rates utilizing the difference between the yield on US Treasury Bonds (or other yield baring assets) and a market rate cost of capital, which provides a method for lenders to generate high quantity of loans while minimizing the need to raise additional capital and realizing higher yields from yield baring assets already owned through lending said assets to user of this invention.

A borrower seeks to originate a new loan, refinance and existing loan, or hedge interest rate risk on a loan. The borrower works with a lender to determine the characteristics of said loan (i.e. floating vs. fixed rate, duration of fixed rate, maturity date, amortization, etc). The lender uses the software (comprised of a proprietary series of algorithm calculators and other components) of the present invention to structure the equivalent loan using US Treasury Bonds or other securities whose cash flows and other characteristics will match the desired loan according to desired characteristics (including yield, duration, and other elements). The lender shorts (borrows the securities from a securities lender and sells those borrowed securities into the market) the equivalent US Treasury Bonds (or other yield generating securities) and uses the proceeds to provide a loan to the borrower. The payments the borrower makes on the resulting loan may then be used by the lender (and also the borrower of shorted securities) as a substitute interest payment for the interest due on the shorted securities. Payments by the borrower may also be used to pay fees associated with securities borrowing, for a profit margin, or for other purposes. The result for the lender is the creation of a loan plus a spread between payments due on the shorted security and payments made by the borrower.

Optional Elements for the Present Invention
Type of Security shorted—i.e. US Treasury Bonds, Bill, Note, non-US sovereign debt, corporate bond, equity etc.
Mixing of securities (type, duration, credit profile)
Full hedge or partial hedge of interest rate on existing loans
Term—number of years, full proceeds up front, or tiered payment of proceeds (like a conventional construction loan)
Maturity—date of maturity, flexible maturity date, partial maturity such as a 50% five year maturity and 50% 10 year maturity
Amortization—balloon, amortizing, level debt service
Collateral position—secured by real estate only or combined with other asset collateral such as a personal guarantee or pledge of personal assets such as other securities
Securitization of a collection of loans to sell into the secondary market
Sell securitized notes from borrowers back to Security Lender in exchange for relief from security loan to loan lender. (may also securitize liability of assets from security lender along with notes from borrowers).
Security Lender receives loan originated with short sale proceeds as collateral for securities borrowed
In the case of a mortgage: type of mortgage, ARM, 1/1, 3/1, 5/1, 7/1. 10/1, etc. vs. fixed 10 year, 15 year, 30 year, etc.
Prospecting System for determining loans and mortgages within a lender's existing portfolio to determine which loans or mortgages would be eligible for the type of funding provided by the invention
Auction method of obtaining securities to short—Potential Security Lenders define or bid the spread they require to lend the securities to the Short Loan Lender, allowing the Short Loan Lender to prioritize securities to short which carry the best terms from Security Lenders. This creates a competitive market for the lending of securities (see detailed description for “Security Lender” and “Short Loan Lender” definitions).
Matching cash flows using face value or market price of securities to be sold short. In low interest rate environments, bonds issued in a higher interest rate environment tend to sell for a premium. For instance, when 30 year US Treasury yields are 3%, a previously issued Treasury bond with a coupon of 6% may trade on the open market for a significantly higher price than it was originally sold for. Specifically, $100 of bonds may trade for $150 or higher, despite the fact that at maturity the borrower must only pay the $100 face value of the bond. The invention provides an option to face value match or market value match loans.
   When a loan is face value matched the invention's calculators and algorithms attempt to match a loan to be made to the face value of securities available to sell short, so for every $100 of loan to be made an attempt to match $100 of face value is attempted. Once that portfolio is constructed, its short sale will result in additional cash being received for the buyer of the security sold short if it is trading at a premium. Using the above example, when $100 of a security is sold $150 of proceeds are realized, even though the $100 of said security sold short is matched to $100 of said loan to be made.
   When a loan is market value matched the invention's calculators and algorithms attempt to match a loan to be made to the market value of securities available to sell short, so for every $100 of loan to be made an attempt is attempt to match $100 of market value is attempted. Once that portfolio is constructed, its short sale may result in less face value of securities sold short than the principal amount of said loan to be made, when interest rates are low and more face value short than principal of the loan when interest rates are high. For instance, when rates are low and bonds are selling at a premium, it may be possible to construct a portfolio to sell short that contains $70,000 of face value of bonds, whose proceeds could fully fund a $100,000 loan.
   The invention also contemplates using a combination of face value and market value matching.

The present invention is unique because it proposes to use among other sources, the most liquid financial market in the world, US Treasuries, to make loans without the inefficient step of involving a GSE. In addition, limits on type of product, collateral position, etc are eliminated and are at the direct discretion of the lender.

Additionally, banks are the primary source of lending for mortgages. They and insurance companies are also large holders of US Treasury securities and similar highly rated securities due to regulatory and internal capital allocation requirements. The present invention allows the holder of the security to loan it out for a premium, create a hedge by shorting the same security, or outright sell its position to enhance the yield of that asset since a premium would be received for its lending.

Differences between our system and standard loans/mortgages:
1. Collateral may include a personal guarantee as well as, or in lieu of, a first mortgage.
2. The Loan Borrower may take the mark to market risk of the short position, creating a speculative position in addition to receiving a loan.
3. Underwriting and approval may include effective closing of loan so that short transaction execution can be automatic within a specified margin (for example, as long as interest rate is between 1.4 and 1.5% execution is authorized without further confirmation). Alternatively a Long Hold can be placed if execution would be outside of approved range or if a Loan Borrower wants to be more involved before execution.
4. Securitization can include a liability for securities borrowed as well as the loans made with the proceeds of security shorting.
   In contrast to the present invention, alternative loans require deposits or other funding sources. One of the unique elements of the present invention is that it involves shorting (i.e. borrowing securities to sell into the market without actually being the primary owner of those securities). The borrower of securities is responsible for making substitute interest payments to the security lending party since the actual security has been sold to another investor. In other words, interest payments from obligor of a security borrowed and sold (i.e. the US Treasury) flow to the party the security was sold to instead of to the owner of the security who lent it for sale.

In addition, short positions may require collateral from the borrower of a security sold short to secure the lender on the transaction. In addition to cash collateral, the present invention contemplates using the loan created, a letter of credit, or credit guarantee, among other possible assets as security for the short position.

The present invention now will be described more fully hereinafter with reference to the accompanying drawings, which are intended to be read in conjunction with both this summary, the detailed description and any preferred and/or particular embodiments specifically discussed or otherwise disclosed. The present invention may, however, be embodied in many different forms and should not be construed as limited to the embodiments set forth herein; rather, these embodiments are provided by way of illustration only and so that this disclosure will be thorough, complete and will fully convey the full scope of the present invention to those skilled in the art.

### BRIEF DESCRIPTION OF THE SEVERAL VIEWS OF THE DRAWING

FIG. 1 (Computer System)—shows a computer and networking system—a computer and network system functionally similar or superior to the one illustrated will implement the present invention.

FIG. 2 (Networking System)—shows a computer network.

FIG. 3 (Overview of Function)—shows the overall function of the present invention and the various elements involved in the present invention's operation.

FIG. 4 (Flow of Payments from Loan Borrower in Non-Securitized Transaction)—shows the flow of payments from a Loan Borrower

FIG. 5 (Flow of Payments from Loan Borrower in Spread Securitized Transaction)—shows the flow of payments from a Loan Borrower when the spread between payments from Loan Borrower and payments due to Security Lender are securitized.

FIG. 6 (Flow of Payments from Loan Borrower in Whole Securitized Transaction)—shows the flow of payments from a Loan Borrower when the loan and its associated liabilities are securitized.

FIG. 7 (Loan Funding Source and Disbursement of Loan Proceeds)—shows the source of capital for making a loan to a Loan Borrower

FIG. 8 (Security Lender Relieving Short Loan Lender's Liability for Securities Borrowed)—shows how the Short Loan Lender may fund a loan by shorting securities and how the Short Loan Lender may be relieved of future liability associated with the loan.

FIG. 9 (Hedging or Partial Refinance Transaction)—shows the cash flows from the Loan Borrower and loan proceeds use when an existing loan is not paid off in full i.e. the hedging transaction or swap.

FIG. 10 (Overview of Structure)—shows a broad view of the structure of the invention.

FIG. 11 (System Algorithm Structure)—shows a detailed view of the system algorithm components of the present invention.

FIG. 12 (Short Security Database Security Lenders)—shows potential security Security Lenders interacting with the Short Security Database.

FIG. 13 (Short Security Database Structure)—shows a detailed view of the short securities database component of the invention.

### DETAILED DESCRIPTION OF THE INVENTION

The present invention is directed to lending/borrowing utilizing the difference between the yield on Treasuries (or other yield baring assets) and a market rate cost of capital.

An amount to borrow, refinance, or hedge is determined by a lender/borrower. Decisions as to term, amortization, floating vs. fixed, collateral, etc are made.

In the case of making a new money loan:

First, the total fund amount the Short Loan Lender will loan the Loan Borrower is determined. Additional features of the loan are also determined such as: the monthly payment, remaining term, amortization, fixed vs. floating interest etc. The present invention's software component conducts several functions including, but not limited to, testing scenarios and creating a structured portfolio of securities, such as face value matching, market value matching, or combination matching. Said structured portfolio will then be used to construct a short position that matches the characteristics entered by a user of the invention. The proceeds from said short position would then be used to fund Loan Borrower's loan. Following issuance of a loan to Loan Borrower, said Loan Borrower begins making payments on said Loan Borrower's loan, e.g. the Short Loan. Said payments by borrower to service said Short Loan are used by the Short Loan Lender to make substitute payments to the Security Lender (lender of the securities that were sold short by said Short Loan Lender). Proceeds of said payments by Loan Borrower to service said Short Loan may also pay any premium required to be paid by said Short Loan Lender to pay for shorted securities, as well as a profit margin for said Short Loan Lender. Thus, said Loan Borrower is ultimately servicing interest and principal payments for securities shorted by said Short Loan Lender plus a spread. This spread may be divided among said Short Loan Lender, said Security Lender (lender of securities that were sold short by said Short Loan Lender), said Loan Borrower, and/or other parties.

In the case of a hedge transaction to make a fixed rate loan floating rate or a floating rate loan fixed:

First, the total fund amount the Short Loan Lender will loan the Loan Borrower is determined. Additional features of the loan are also determined such as: the monthly payment, remaining term, amortization, fixed vs. floating interest etc. Ideally, the fixed/floating rate loan is owned by said Short Loan Lender in the new transaction so that the payments of the fixed/floating rate loan can be easily altered. Alternatively, the entire loan can be structured as a new Short Loan eliminating any need to share collateral position. Alternatively, the hedge can be structured around the payments of the fixed/floating rate loan, though in the case where the monthly payment is fixed regardless of outstanding principal balance the use of the hedge would be to shorten the term of the loan because payments on the fixed rate loan would continue as they did before the transaction. Since the transaction proceeds would be used to partially pre-pay the pre-existing fixed/floating rate loan, future payments on the pre-existing fixed/floating rate loan would amortize the loan at an accelerated rate. The present invention's software component conducts several functions including, but not limited to, testing scenarios and creating a structure for any alternatives. A short transaction is consummated and proceeds from said short transaction are used to partially or fully pre-pay said pre-existing fixed/floating rate loan. Said Loan Borrower then continues to make payments under altered terms on said pre-existing fixed/floating rate loan or they continue to make payments as scheduled resulting in an accelerated amortization of said pre-existing fixed/floating rate loan. Said Loan Borrower also begins making payments on said Short Loan. Said Loan Borrower's payments are used by said Short Loan Lender to make substitute payments to said Security Lender (loans the shorted securities to the Short Loan Lender), any premium required by said Security Lender for said Short Loan Lender to pay, and a margin for said Short Loan Lender. Thus, said Loan Borrower is ultimately paying the same interest rate as the securities shorted by said Short Loan Lender plus a spread. This spread may be divided among said Short Loan lender, said Security Lender (lender of securities that were sold short by said Short Loan Lender), said Loan Borrower, and/or other parties.

In order to implement the goals of the present invention, illustrations are provided to help describe the present invention's structure and functionality.

### DETAILED DESCRIPTION OF THE DRAWINGS

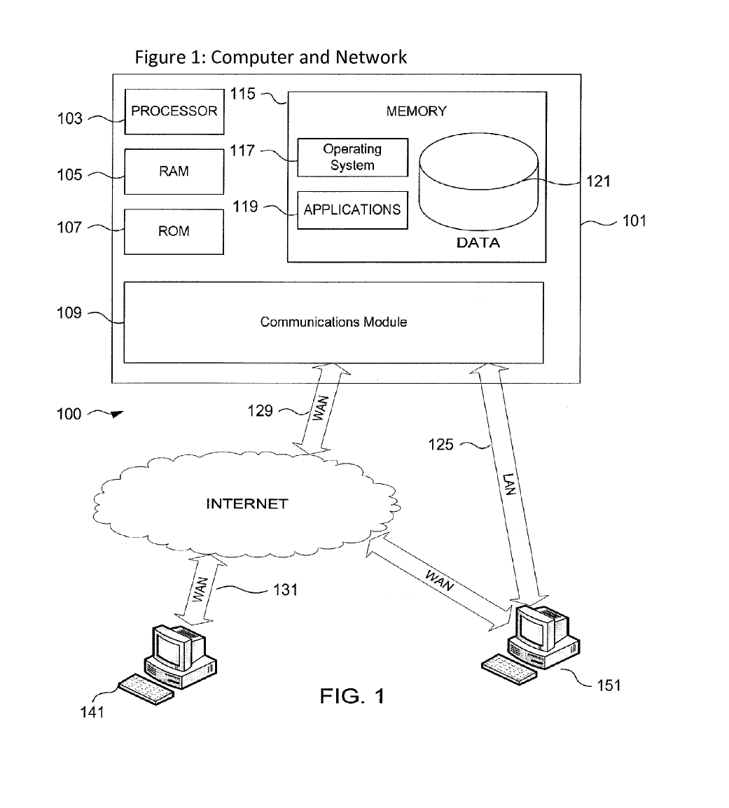

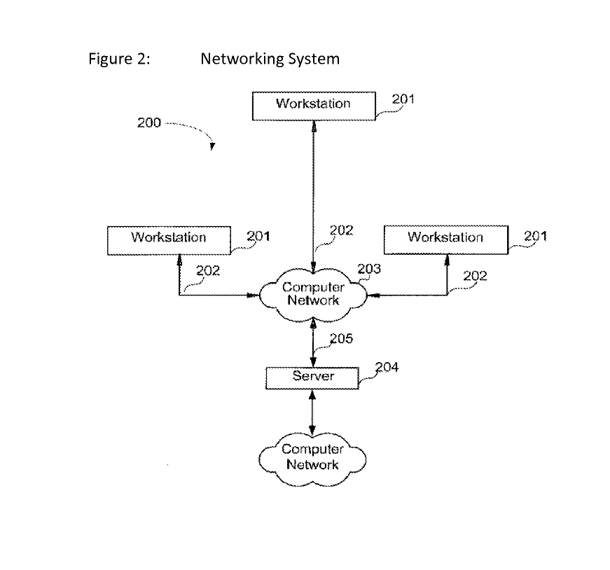

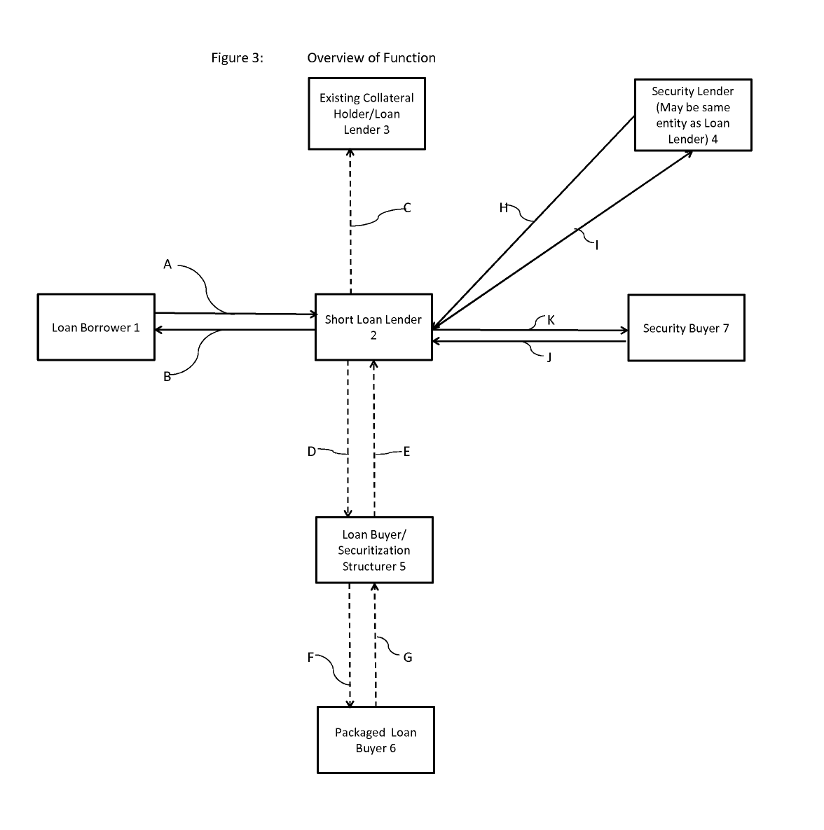

The present invention encompasses elements that are prior art and thus not novel (FIGS. 1-2) as well as elements that are novel (FIGS. 3-13). Elements of FIGS. 1-2 may be used in conjunction with elements in FIG. 3-13 to achieve the desired results of the present invention. FIGS. 1-2 reflect standard practices for computers and networks.

### FIG. 1 (Computer and Networking System)

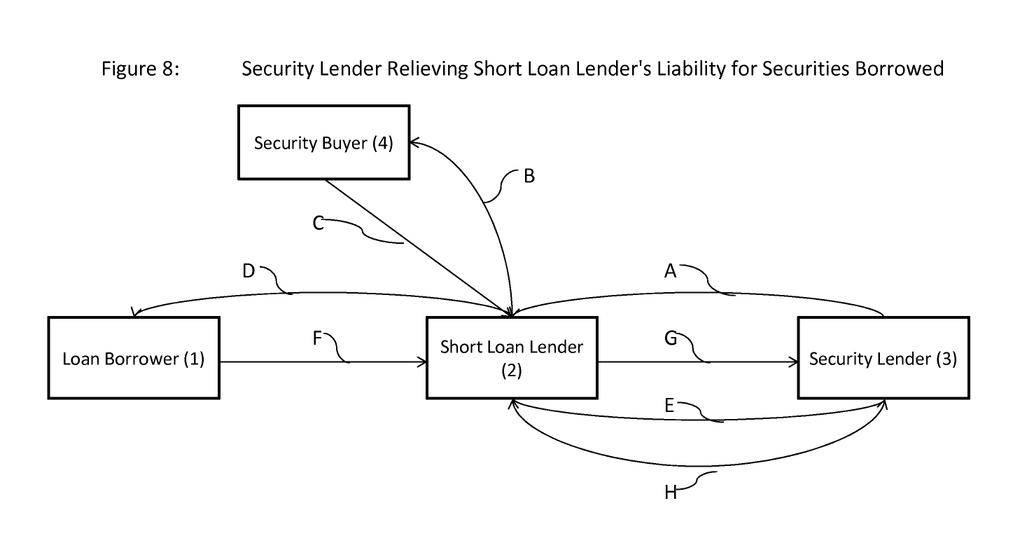

The network connections depicted in FIG. 8 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the embodiments is contemplated. For example, aspects of the method steps disclosed herein may be executed on a processor on a computing device 101. Such a processor may execute computer-executable instructions stored on a computer-readable medium.

### FIG. 2 (Networking System)

Referring to FIG. 2, an illustrative system 200 for implementing methods according to some embodiments is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

### FIG. 3 (Overview of Function)

FIG. 3 shows the overall function of the present invention and the various parties involved in its operation and a summary of those interactions. A Short Loan Lender/Security Buyer engages a potential Loan Borrower who desires a loan for a purpose such as buying or refinancing a house (a mortgage). The Short Loan Lender and Loan Borrower work through the underwriting process as in any conventional loan. The Short Loan Lender then makes a formal offer to make a loan. If the Loan Borrower accepts, then the Short Loan Lender operates the portion of the invention that determines the portfolio of securities to borrow from a Security Lender. The Short Loan Lender then borrows those securities and sells them to a security buyer, creating a short position in the securities sold, and receives proceeds from the Security Buyer. The Short Loan Lender then distributes proceeds to the Loan Borrower, and if appropriate and in existence then proceeds are also distributed to the Existing Collateral Holder. At that point a loan has been made and the Short Loan Lender is free to pursue options, such as securitization of the loan or multiple loans.

Definitions for FIG. 3 (Numbers Relate to Those Found in the Figure):
1. Loan Borrower—A person or entity who desires upfront use of funds in exchange for making regular payments of principal and interest (in a standard loan this would be the entity borrowing funds to make a property purchase or refinance). For example, the Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company).
3. Existing Collateral Holder—If the Loan Borrower (1) has a loan secured by the Loan Borrower's (1) property, then lender that owns the secured loan is the Existing Collateral Holder.
4. Security Lender—A person/entity with the ability to loan securities/assets to the Short Loan Lender (2).
5. Loan Buyer/Securitization Structurer—A person/entity that securitizes loans—by taking loans whether it be one or a combination of loans (secured notes from the Loan Borrower (1) that are provided by the Short Loan Lender (2) in exchange for funds, relief of liability or other consideration and preparing loans to be sold as a security.
6. Packaged Loan Buyer—The purchaser of a security or multiple securities prepared by the Loan Buyer/Securitization Structurer (5).
7. Security Buyer—purchases securities/assets from the Short Loan Lender (2) that the Short Loan Lender (2) borrowed from the Security Lender (4). This enables the Short Loan Lender (2) to go short a security/asset.

### Interaction Between Elements of the FIG. 3 (Letters Relate to Those Found in the Figure):

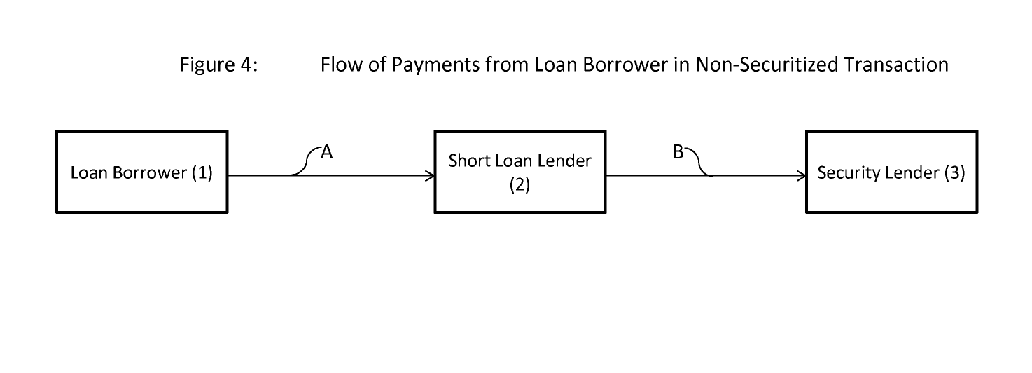

A. Loan Borrower (1) makes payments of principal and interest to Short Loan Lender (2)
B. Proceeds derived from shorting securities/assets go to Loan Borrower (1). This is the money the Loan Borrower (1) uses to purchase or refinance a property/asset. (Proceeds that were borrowed by Short Loan Lender (2) from Security Lender (4) go to two envisioned sources. The Loan Borrower (1) and, if present, the Existing Collateral Holder (3))
C. Proceeds derived from Short Loan Lender's (2) shorting securities/assets pays all or a portion of Existing Collateral Holder (3) if said Existing Collateral Holder exists.
D. Short Loan Lender (2) passes through or assigns payments from Loan Borrower (1) to Loan Buyer/Securitization Structurer (5) in order for Loan Buyer/Securitization Structurer to then sell a security based on the loan between the Loan Borrower (1) and Short Loan Lender (2).
E. Loan Buyer/Securitization Structurer (5) pays Short Loan Lender (2) for the market value of the loan made to Loan Borrower (1). These payments may be in installments, royalties, in its entirety, or some other form. In another embodiment, the Loan Buyer/Securitization Structurer (5) pays the Short Loan Lender (2) a market price for the net value of a Loan. The net value of a Loan is determined by valuing the net payments (payments owed by the Loan Borrower (1) to the Short Loan Lender (2) minus payments owed by the Short Loan Lender (2) to the Security Lender (4). In this case, the Loan Buyer/Securitization Structurer assumes both the asset (the payments by the Loan Borrower (1) and a liability (the payments to the Security Lender (4).
F. The Loan Buyer/Securitization Structurer (5) sells a security to the Packaged Loan Buyer (6). The value of the security purchased by the Packaged Loan Buyer is linked to a stream of cash flows from loans (secured notes from the Loan Borrower (1) that are provided in the Short Loan Lender (2) in exchange for funds)
G. Packaged Loan Buyer (6) pays the Loan Buyer/Securitization Structurer (6) for the security purchased
H. Security Lender (4) lends Securities or assets to Short Loan Lender (2). For example, Short Loan Lender (2) borrows US Treasury bonds from Security Lender (4). The purpose of Short Loan Lender (2) borrowing these US Treasury bonds is to sell the US Treasury bonds to buyers in a marketplace. In sum, the Short Loan Lender (2) is selling the US Treasury bonds short.
I. Short Loan Lender (2) makes payments in lieu and other applicable lending fees to Security Lender (4). For example, Security Lender (4) lends treasuries to Short Loan Lender (2) in exchange for cash flow of treasury coupon plus a negotiated premium.
J. Security Buyer (7) purchases securities/assets in the marketplace (that were shorted by Short Loan Lender (2)) and proceeds are received by Short Loan Lender (2). Securities or assets borrowed by Short Loan Lender (2) are delivered to Security Buyer (7). For example, Short Loan Lender (2) sells short US Treasury bonds that are borrowed from the Security Lender (4). The short sale may occur at the same time of borrowing US Treasury bonds or after said borrowing occurs.
K. Securities or assets borrowed by Short Loan Lender (2) are delivered to Security Buyer (7). For example, Short Loan Lender (2) sells short US Treasury bonds that are borrowed from the Security Lender (4). The short sale may occur at the same time of borrowing US Treasury bonds or after said borrowing occurs. Clearing (the process of completing a transaction that results in the transfer of securities in exchange for an asset that may involve a disinterested third party intermediary) such a transaction may occur under negotiated terms or under normal market clearing practices.
   FIG. 4 (Flow of Payments from Loan Borrower in Non-Securitized Transaction)

FIG. 4 shows the flow of payments from a Loan Borrower. A Loan Borrower makes payments to the Short Loan Lender. The Short Loan Lender uses the proceeds of those payments to pay the Security Lender for the privilege of borrowing securities that were sold to fund the loan.

Definitions for FIG. 4 (Numbers Relate to Those Found in the Figure):
1. Loan Borrower—A person or entity who desires upfront use of funds in exchange for making regular payments of principal and interest (in a standard loan this would be the entity borrowing funds to make a property purchase or refinance). The Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company) or its assignees such as a trustee, servicer, custodian, etc.
3. Security Lender—A person/entity with the ability to loan securities/assets to the Short Loan Lender (2).

### Interaction Between Elements of the FIG. 4 (Letters Relate to Those Found in the Figure):

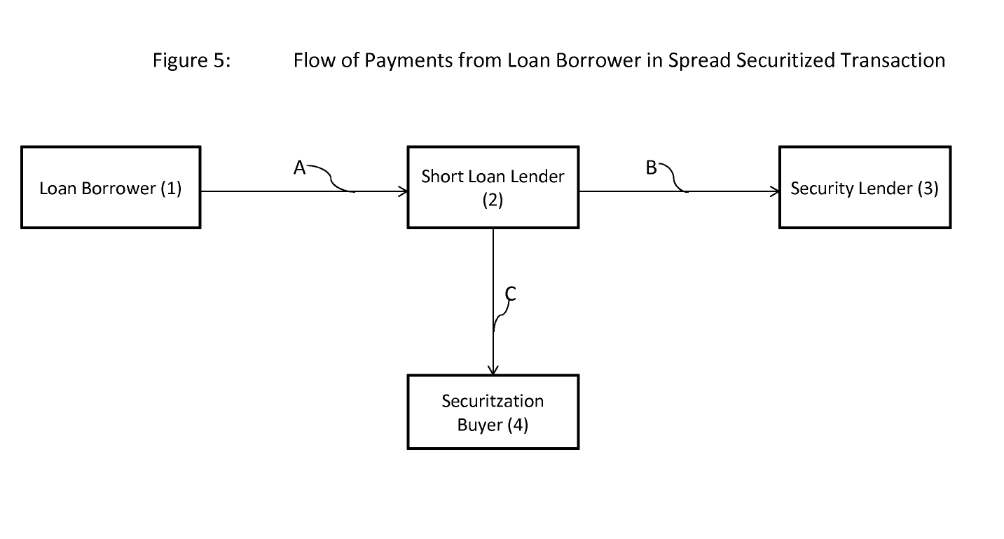

A. Loan Borrower (1) makes regular principal and interest payments to Short Loan Lender (2). This is done in a similar fashion to a conventional loan. The Loan Borrower (1) may, but is not required, to abide by restrictive covenants, including, but not limited to, inability to prepay principal, absence of grace periods, inability to refinance, mark to market penalty for prepayment, yield maintenance, etc.
B. Short Loan Lender (2) makes payments in lieu and pays other applicable premiums and fees to Security Lender (3) or its assignees who previously loaned securities to Short Loan Lender (2). Short Loan Lender (2) may keep part of the payment (A) from the Loan Borrower (1) as profit, for reserves, for operational purposes, or for any other cause.
   FIG. 5 (Flow of Payments from Loan Borrower in Spread Securitized Transaction)

FIG. 5 shows the flow of payments from a Loan Borrower when the spread between payments from Loan Borrower and payments due to Security Lender are securitized. A Loan Borrower makes payments to the Short Loan Lender. The Short Loan Lender then makes payments to the Securitization Buyer who has purchased the right to receive cash flows from the Loan Borrower of the loan. The Short Loan Lender also uses proceeds received to make payments to the Security Lender for the privilege of borrowing securities that were sold to fund the loan.

Definitions for FIG. 5 (Numbers Relate to Those Found in the Figure):
1. Loan Borrower—A person or entity who desires upfront use of funds in exchange for making regular payments of principal and interest (in a standard loan this would be the entity borrowing funds to make a property purchase or refinance). The Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company), or its assignees such as a trustee, servicer, custodian, etc.
3. Security Lender—A person or entity with the ability to loan securities/assets to the Short Loan Lender (2).
4. Securitization Buyer—A person or entity who has purchased the securitized loan (or portion thereof) of the Loan Borrower (1) usually through an intermediary.

### Interaction Between Elements of the FIG. 5 (Letters Relate to Those Found in the Figure):

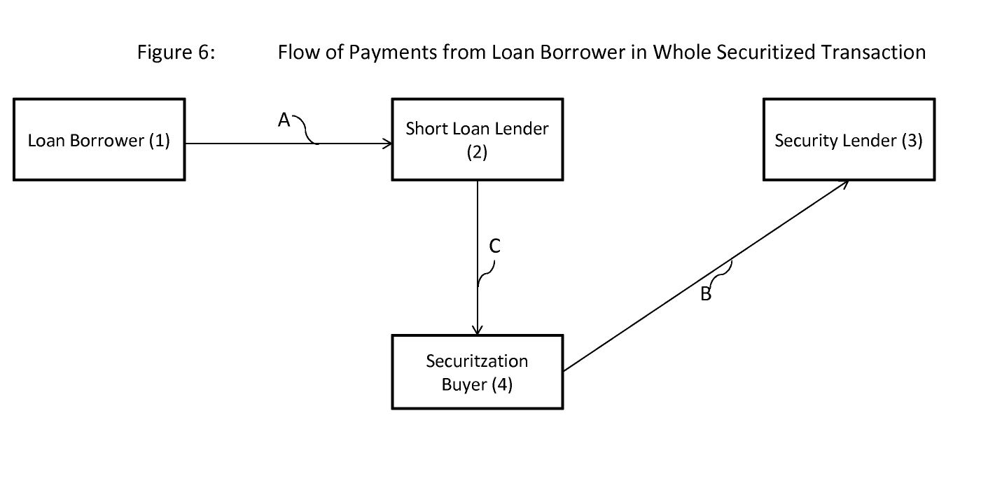

A. Loan Borrower (1) makes regular principal and interest payments to Short Loan Lender (2). This is done in a similar fashion to a conventional loan. The Loan Borrower (1) may, but is not required, to abide by restrictive covenants, including, but not limited to, inability to prepay principal, absence of grace periods, inability to refinance, mark to market penalty for prepayment, yield maintenance, etc.
B. Short Loan Lender (2) makes payments in lieu and pays other applicable premiums and fees to Security Lender (3) or its assignees who previously loaned securities to Short Loan Lender (2). Short Loan Lender (2) may keep part of the payment (A) from the Loan Borrower (1) as profit, for reserves, for operational purposes, or for any other cause.
C. Short Loan Lender (2) makes payments to Securitization Buyer (4) equal to all or a portion of the difference between what Loan Borrower (1) pays (A) and what is due (B) to the Security Lender (3) dependent on the terms of the security created as a result of the securitization of all or a portion of the Loan Borrower (1) loan.
   FIG. 6 (Flow of Payments from Loan Borrower in Whole Securitized Transaction)

FIG. 6 shows the flow of payments from a Loan Borrower when the loan and its associated liabilities are securitized. A Loan Borrower makes payments to the Short Loan Lender. The Short Loan Lender then makes a payment to the Securitization Buyer who has purchased not only the loan payments from the Loan Borrower, but the corresponding liability to the Security Lender for the securities borrowed to fund the loan to the Loan Borrower. The Securitization Buyer is then responsible for making payments to the Security Lender for the privilege of borrowing securities that were used to fund the loan.

Definitions for FIG. 6 (Numbers Relate to Those Found in the Figure):
1. Loan Borrower—A person or entity who desires upfront use of funds in exchange for making regular payments of principal and interest (in a standard loan this would be the entity borrowing funds to make a property purchase or refinance). The Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company) or its assignees such as a trustee, servicer, custodian, etc.
3. Security Lender—A person/entity with the ability to loan securities/assets to the Short Loan Lender (2).
4. Securitization Buyer—A person or entity who has purchased the securitized loan (or portion thereof) of the Loan Borrower (1) usually through an intermediary along with a corresponding liability to the Security Lender (3) associated with securities borrowed by Short Loan Lender (2) whose short sale proceeds were used to fund a loan to the Loan Borrower (1).

### Interaction Between Elements of the FIG. 6 (Letters Relate to Those Found in the Figure):

A. Loan Borrower (1) makes regular principal and interest payments to Short Loan Lender (2). This is done in a similar fashion to a conventional loan. The Loan Borrower (1) may, but is not required, to abide by restrictive covenants, including, but not limited to, inability to prepay principal, absence of grace periods, inability to refinance, mark to market penalty for prepayment, yield maintenance, etc.
B. Securitization Buyer (4) makes payments in lieu and pays other applicable premiums and fees to Security Lender (3) or its assignees who previously loaned securities to Short Loan Lender (2). Securitization Buyer (4) has the right to keep proceeds of payment (A) from the Loan Borrower (1) as profit, for reserves, for operational purposes, or for any other cause, once payments (B) are made.
C. Short Loan Lender (2) makes payments to Securitization Buyer (4) equal to all or a portion of what Loan Borrower (1) pays (A) to the Security Lender (3) dependent on the terms of the security created as a result of the securitization of all or a portion of the Loan Borrower (1) loan.

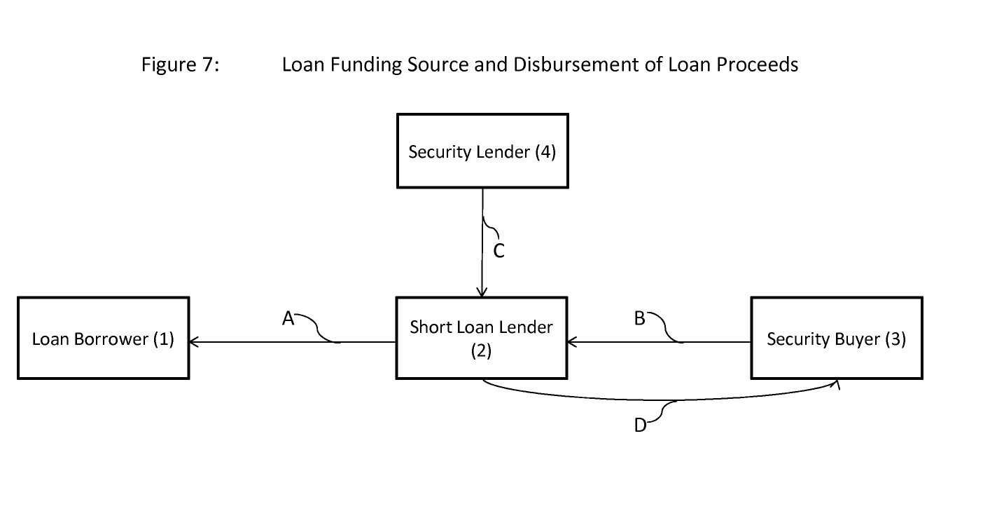

### FIG. 7 (Loan Funding Source and Disbursement of Loan Proceeds)

FIG. 7 shows the source of capital for making a loan to a Loan Borrower. A Short Loan Lender borrows securities from a Security Lender. The Short Loan Lender then sells those securities borrowed to a Security Buyer. That Security Buyer pays the Short Loan Lender for the securities bought and the Short Loan Lender uses the proceeds of that sale to fund a loan to the Loan Borrower.

### Definitions for FIG. 7 (Numbers Relate to Those Found in the Figure):

1. Loan Borrower—A person or entity who desires upfront use of funds in exchange for making regular payments of principal and interest (in a standard loan this would be the entity borrowing funds to make a property purchase or refinance). The Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company) or its assignees such as a trustee, servicer, custodian, etc.
3. Security Buyer—A market participant who purchases securities/assets sold and borrowed by the Short Loan Lender (2) from the Security Lender (4).
4. Security Lender—A person/entity with the ability to loan securities/assets to the Short Loan Lender (2).

### Interaction Between Elements of the FIG. 7 (Letters Relate to Those Found in the Figure):

A. Short Loan Lender (2) distributes proceeds to the Loan Borrower (1) in the form of a loan.
B. Security Buyer (3) pays Short Loan Lender (2) for securities bought through standard market clearing practices.
C. Security Lender (4) delivers securities borrowed by Short Loan Lender (2) to Short Loan Lender (2).
D. Short Loan Lender (2) delivers securities to Security Buyer (3) through standard market clearing practices.

### FIG. 8 (Security Lender Relieving Short Loan Lender's Liability or Accepting Short Loan as Collateral for Securities Borrowed)

FIG. 8 shows how the Short Loan Lender may fund a loan by shorting securities and be relieved of future liability associated with the loan. A Short Loan Lender borrows securities from a Security Lender. The Short Loan Lender then sells those securities borrowed to a Security Buyer. Security Buyer pays the Short Loan Lender for the securities bought, and the Short Loan Lender uses the proceeds of that sale to fund a loan to the Loan Borrower. At that point the Short Loan Lender sells or otherwise disposes of both the loan and cash flows due on that loan and associated liability from the securities borrowed and sold to the Security Lender, thus relieving the Short Loan Lender of future liability associated with the securities borrowed. The Security Lender has agreed to accept the loan payments from the Loan Borrower in lieu of maintaining a securities loan with the Short Loan Lender. Alternatively, the Short Loan Lender may retain liability to the Security Lender for securities shorted, but may allow the Security Lender to hold the loan made to the Loan Borrower as collateral for securities loaned. In this embodiment, the Security Lender would then rebate a portion of the spread to the Short Loan Lender.

### Definitions for FIG. 8 (Numbers Relate to Those Found in the Figure):

1. Loan Borrower—A person or entity who desires upfront use of funds in exchange for making regular payments of principal and interest (in a standard loan this would be the entity borrowing funds to make a property purchase or refinance). The Loan Borrower may be the owner of residential real estate, commercial real estate, or other assets.
2. Short Loan Lender—A person or entity who uses proceeds of the sale of borrowed securities to make a Loan (in a standard loan, this would be a bank, credit union, or mortgage company) or its assignees such as a trustee, servicer, custodian, etc.
3. Security Lender—A person/entity with the ability to loan securities/assets to the Short Loan Lender (2).
4. Security Buyer—A market participant who purchases securities/assets sold and borrowed by the Short Loan Lender (2) from the Security Lender (3).

### Interaction Between Elements of the FIG. 8 (Letters Relate to Those Found in the Figure):

A. Security Lender (3) delivers securities borrowed by Short Loan Lender (2) to Short Loan Lender (2).
B. Short Loan Lender (2) delivers securities to Security Buyer (4) through standard market clearing practices.
C. Security Buyer (3) pays Short Loan Lender (2) for securities bought through standard market clearing practices.
D. Short Loan Lender (2) makes loan to Loan Borrower (1) in exchange for promissory note and other conventional and optional covenants of receiving a loan.
E. Short Loan Lender (2) delivers Security Lender (3) whole, partial, or securitized promissory notes from Loan Borrower (1) in exchange for relief of all or partial liability associated with borrowing of securities (A) from Security Lender (3)
F. Loan Borrower (1) makes regular principal and interest payments to Short Loan Lender (2). This is done in a similar fashion to a conventional loan. The Loan Borrower (1) may, but is not required, to abide by restrictive covenants, including, but not limited to, inability to prepay principal, absence of grace periods, inability to refinance, mark to market penalty for prepayment, yield maintenance, etc.
G. Security Lender (3) receives pass through payments from Loan Borrower (1) through Short Loan Lender (2) minus applicable fees, royalties, premiums, etc associated with originating and administering the loan.
H. In one embodiment, instead of relief of liability, Short Loan Lender (2) may still be held liable for losses or gains on securities borrowed; however, the Security Lender (3) may accept the Short Loan to the Loan Borrower (1) as collateral for securities borrowed. In this case, the Security Lender (3) would be liable to make rebate payments to the Short Loan Lender (2) for its Net Portion (the entire payment from the Loan Borrower (1) less amounts that would be payable to the Security Lender (2) for the borrowing of securities) of the payment on said Short Loan.

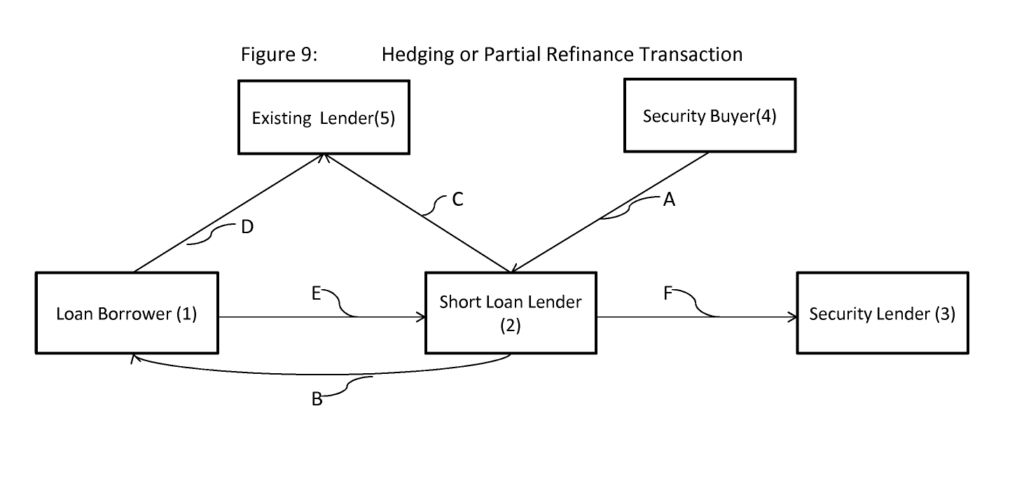

### FIG. 9 (Hedging or Partial Refinance Transaction)

FIG. 9 shows the cash flows from the Loan Borrower and loan proceeds use when an existing loan is not paid off in full (i.e. the hedging transaction or swap). Short Loan Lender borrows securities from a Security Lender. The Short Loan Lender then sells those securities borrowed to a Security Buyer. That Security Buyer pays the Short Loan Lender for the securities bought and the Short Loan Lender uses a portion of the proceeds of that sale to make a partial payoff to the Existing Lender who holds a collateral position or is otherwise entitled to receive payments from a Loan Borrower. The principal balance and thus cash flows due to the Existing Lender are thus reduced. The Short Loan Lender may also distribute a portion of the proceeds to fund a loan to the Loan Borrower. The Loan Borrower then makes payments on the remainder of the loan from the Existing Lender and also makes payments to the Short Loan Lender who had previously made a payment to the Existing Lender reduce the balance due from the Loan Borrower.

### Definitions for FIG. 9 (Numbers Relate to Those Found in the Figure):

1. Loan Borrower—A person or entity who desires upfront use of funds in exchange for making regular payments of principal and interest (in a standard loan this would be the entity borrowing funds to make a property purchase or refinance). The Loan Borrower (1) may be the owner of residential real estate, commercial real estate, or other assets. In addition Loan Borrower (1) has other outstanding loans or debts due to other Existing Lender(s) (5).
2. Short Loan Lender—A person or entity who uses proceeds of the sale of borrowed securities to make a Loan (in a standard loan, this would be a bank, credit union, or mortgage company) or its assignees such as a trustee, servicer, custodian, etc.
3. Security Lender—A person/entity with the ability to loan securities/assets to the Short Loan Lender (2).
4. Security Buyer—A market participant who purchases securities/assets sold and borrowed by the Short Loan Lender (2) from the Security Lender (3).
5. Existing Lender—The lender(s) of loan(s) to the Loan Borrower (1) who may also hold property as collateral that is contemplated to act as collateral for a loan (B).

### Interaction Between Elements of the FIG. 9 (Letters Relate to Those Found in the Figure):

A. Security Buyer (3) pays Short Loan Lender (2) for securities bought through standard market clearing practices.
B. Short Loan Lender (2) makes loan to Loan Borrower (1) from partial proceeds of a short sale (A) in exchange for promissory note and other conventional and optional covenants of receiving a loan.
C. Short Loan Lender (2) makes payment to Existing Lender (5) from partial proceeds of a short sale (A) which was also used to make partial payment in the form a loan (B) to Loan Borrower (1). Payment (C) is used to reduce principal outstanding and obtain other covenant relief, partial or full release of collateral securing existing loan, or modifications of other terms from Existing Lender (5) to be compatible with the goals of the Loan Borrower (1) which may be to partially refinance a transaction, hedge interest rate exposure through reducing fixed rate debt in exchange for floating rate debt or exchanging floating rate debt in exchange for fixed rate debt.
D. Loan Borrower (1) makes modified payments to reflect partial payment (C) of existing loan from Existing Lender (5).
E. Loan Borrower (1) makes regular principal and interest payments to Short Loan Lender (2). This is done in a similar fashion to a conventional loan. The Loan Borrower (1) may, but is not required, to abide by restrictive covenants, including, but not limited to, inability to prepay principal, absence of grace periods, inability to refinance, mark to market penalty for prepayment, yield maintenance, etc.
F. Short Loan Lender (2) makes payments in lieu and pays other applicable premiums and fees to Security Lender (3) or its assignees who previously loaned securities to Short Loan Lender (2). Short Loan Lender (2) may keep part of the payment (A) from the Loan Borrower (1) as profit, for reserves, for operational purposes, or for any other cause. Alternatively Short Loan Lender (2) distributes proceeds or proceeds flow as described in FIGS. 4, 5, 6, 7, etc.

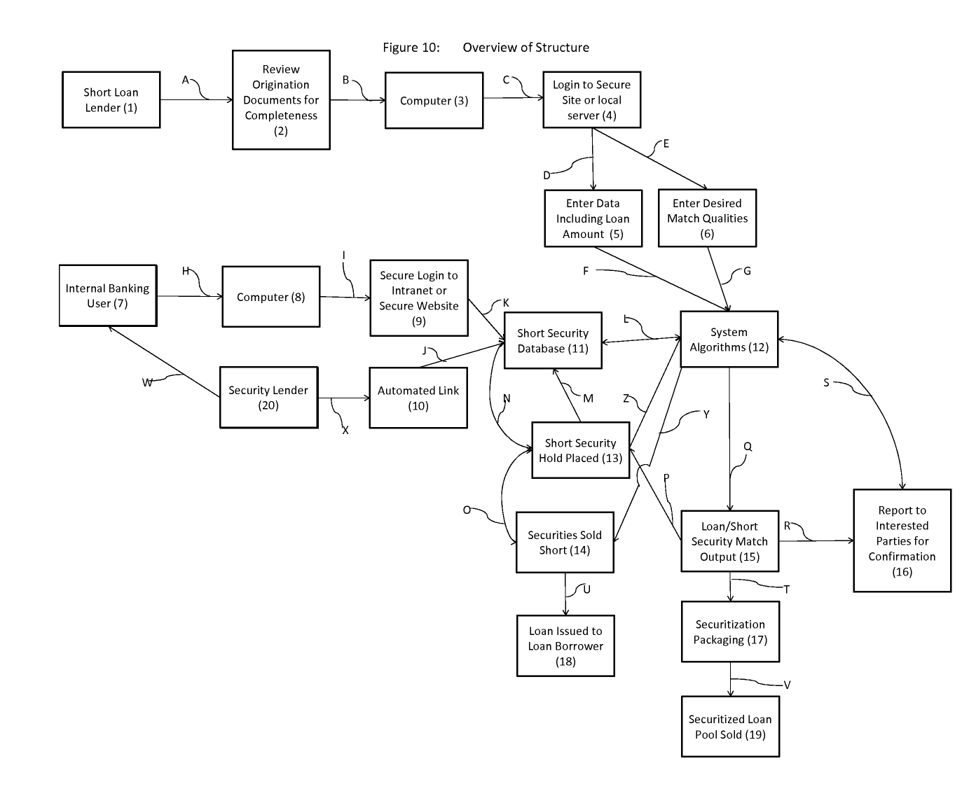

### FIG. 10 (Overview of Structure)

FIG. 10 shows a broad view of the structure of the invention. The Short Loan Lender reviews an application for a loan. If approved, the Short Loan Lender then uses a computer to begin entering information from the application and also enters information required to make a match of securities to short and a loan. Separately, an Internal Banking User works with potential Security Lenders to make securities available to borrow. The Internal Banking User utilizes a computer to maintain a database of securities available to lend. Alternatively, the Security Lender may directly enter information into the Short Security Database.

The System Algorithm uses the information provided by the Short Loan Lender and information provided within the Short Security Database by Internal Banking Users and Security Lenders to match cash flows from the potential loan to cash flows required to service securities available to borrow. The System Algorithms place hold on Securities in the Short Security Database to mark them for potential borrowing and subsequent sale to fund a loan from the Short Loan Lender. This process may happen quickly and automatically or the System Algorithms can place a longer hold on securities contained within the Short Security Database to allow for manual confirmation from interested parties such as the Short Loan Lender and Loan Borrower. The invention then sells the securities short by borrowing securities available in the Short Security Database and selling those borrowed securities into a market. After selling securities short and making a loan the invention then provides the option of pooling and/or dividing loans for the purposes of sale in a Securitization.

### Definitions for FIG. 10 (Numbers Relate to Those Found in the Figure):

1. Short Loan Lender—An individual or entity who is serving as the Short Loan Lender/Security Borrower and facilitator of a Short Loan Transaction
2. Review Origination Documents for Completeness—Origination Documents include, but are not limited to, items such as a loan application, information on existing loans to be refinanced, appraisals of collateral, credit checks, background checks, and other related documents
3. Computer—A device that allows interaction with programs and algorithms over a distance or locally in an electronic format. May also include smart phones, tablets, or other devices capable of operating programs based on algorithms.
4. Login to remote or local server—Gaining access to the data contents and processing capabilities of a Computer or Network
5. Enter Data Including Loan Amount—Individual items of data are manually or automatically input to the System Algorithm (12). Items may include, but are not limited to, credit score, demographic information, appraisal information, previous/existing loan details, collateral information, asset information, income information, loan amount, loan duration, maturity, interest mode (mixed, fixed, variable), maturity schedule, payment information, etc.
6. Enter Desired Match Qualities—Individual items of data are manually or automatically input to the invention. Data may include, but is not limited to, credit risk tolerance, types of securities to be shorted, cash flow match tolerance, type of maturity match (face value match, market value match, combination match, or other continuum between face and market value match) etc. are manually or automatically input.
7. Internal Banking User—utilizes a computer or computing device in order to facilitate a match between the borrower's loan request and the available shortable securities/assets by maintaining, seeking out, initiating, negotiation, or otherwise procuring commitments or indications of interest to make securities available to be shorted through the Short Security Database (11).
8. Internal Banking Computer—A device that allows interaction with programs and algorithms over a distance or locally in an electronic format. May also include smart phones, tablets, or other devices capable of operating programs based on algorithms.
9. Secure Login to Intranet or Secure Website—Gaining access to the data contents and processing capabilities of a Computer or Network
10. Automated link—Utilizes a computer and/or network connection to participants or owners of securities that are included in the Short Security Database (11) that allows the owners of those securities to update security availability, including, but not limited to, making new securities available, withdrawing security availability, making changes to the amount of each security available, changing the terms of borrowing securities available, within the Short Security Database (11).
11. Short Security Database—A database consisting of a repository of information provided by client institutions, licensees, customers, or other entities that are part of the system whose primary purpose is to catalog Securities available to be borrowed for the purpose of initiating a Short Position. Data collected and displayed includes, but is not limited to, amount of security available, CUSIP number of security, other indentifying information of security, terms of lending security (such as premium required or duration of loan).
12. System Algorithms—Software or other automated system that attempts to match loan data and Short Security Database (11) information for the purpose of structuring a loan and short position.
13. Short Security Hold Placed (Optional)—The reservation of securities available in the Short Security Database once matched to a prospective loan for the purpose of reserving securities in the Short Securities Database (11) for a particular transaction, effectively locking the terms of a loan (within specified tolerances) for a specific period of time.
14. Securities Sold Short—The act of entering into two securities transactions. First, securities are borrowed from an entity having right to lend such securities. Second, the borrowed securities are then sold to a third party. For example, Bank A borrows 1 share of Micro Inc. stock from Bank B that owns Micro Inc. stock. Bank A then sells 1 share of Micro Inc. stock to Bank A's client named Bob Smith. Bob Smith then owns 1 share of Micro Inc. stock and Bank A owes Bank B 1 share of Micro Inc. stock.
15. Loan/Short Security Match Output—A data display or other output that contains, but is not limited to, a portfolio of securities that when sold short would most closely replicate the desired cash flows and maturities of a Short Loan (definition of “Short Loan”=the loan made by the Short Loan Lender (1) to the Loan Borrower, funded through the sale of Securities borrowed from a Security Lender), proposed cash flows and amortization table of said Short Loan and portfolio of securities to sell short including applicable reserve funds, deviation and variance information from precise desired cash flows, location of securities, availability of such securities, credit risk grades of securities and proposed loan, transaction credit deviation risk of deviation in credit risks of securities portfolio and loan.
16. Report to Interested Parties for Confirmation (Optional)—A report to the Short Loan Lender (1) for purposes of confirming terms and execution of a Short Loan with the Loan Borrower, placing a Short Security Hold (13), reporting to regulatory authorities, or for other purposes.
17. Securitization Packaging—The aggregation of multiple loans for the purpose of combining into larger single securities for further division and sale to market. Another embodiment considers the aggregation of multiple loans to Loan Borrowers with their corresponding liability (short securities owed to Security Lender).
18. Loan Issued to End Loan Borrower—The execution of documents, payment of funds, receipt of promissory notes and collateral pledge, and other items required related to making a Loan.
19. Securitized Loan Pool Sold—Sale of securities to market whose contents are comprised of Short Loans.
20. Security Lender—A person/entity with the ability to loan securities/assets to the Short Loan Lender (1).

### Interaction Between Elements of the FIG. 10 (Numbers Relate to Those Found in the Figure):

A. Short Loan Lender (1) examines physical or electronic documents submitted for the purpose of obtaining a loan.
B. Short Loan Lender (1) interacts with a Short Loan Lender Computer (2).
C. Short Loan Lender (1) inputs login data, password, and other required security information into a program or web browser.
D. Short Loan Lender (1) enters pertinent information that was previously reviewed into a local or remote program
E. Short Loan Lender (1) enters information related to the qualities of desired loan, tolerances
F. Data enters System Algorithm (12) for processing
G. Data enters System Algorithm (12) for processing
H. Internal Banking User (7) interacts with Internal Banking Computer (8)
I. Internal Banking User (7) logs in to Internal Banking Computer (8)
J. Security Lender (20) uses internal resources or resources such as programs provided by Short Security Database (11) owner or manager to update Short Security Database (11) using an automated secure connection.
K. Internal Banking User (7) makes changes to the Short Security Database (11).
L. Short Security Database (11) sends current available portfolio of shortable securities/assets to the System Algorithm (12) Program interacts with Short Security Database (11) and Short Security Database (11) submits information to System Algorithms (12). System Algorithms (12) may, but is not required to, make changes to Short Security Database (11)
M. System Algorithms (12) interacts with Short Security Database (11) to confirm availability of securities and gives notice of imminent borrowing of securities.
N. Short Security Database (11) confirms that a hold is placed.
O. Short Security Hold Placed (13) confirms that securities are borrowed and sold (Securities Sold Short (14), which then indicates that the Short Security Database (11) should be updated to reflect this transaction and Security Lender (20) is informed.
P. The Loan/Short Security Match Output (15) communicates the portfolio of securities identified to the Short Security Hold Placed (13).
Q. System Algorithms (12) utilize the Short Security Database (11) to form a portfolio of securities to sell short (henceforth “loan/short security match output”).
R. The Loan/Short Security Match Output (15), after receiving information from the System Algorithms (12) to generate the match of securities to short for the present loan, then sends this result to users, other interested parties.
S. Interested parties confirm desire to execute transaction with System Algorithms (12).
T. The information garnered from the Loan/Short Security Match Output (15) is sent to the Securitization Packaging (17) in order to aggregate output of other individual transactions for the purpose of generating securities.
U. Securities Sold Short (14) triggers the Loan Issued to Loan Borrower (18) which results in funds being provided to the Loan Issued to Loan Borrower (18) in exchange for a secured note on the property/asset owned by the Loan Issued to Loan Borrower (18)
V. Securities packaged by the Securitization Packaging (17) are sent to Securitized Loan Pool Sold (19), which may be rated by a rating agency to receive a grade, designation numbers are obtained, and securities are sold into available markets, or other steps required to ultimately sell such a Securitization Package to a buyer.
W. Security Lender (20) interacts with Internal Banking User (7).
X. Security Lender (20) initiates or otherwise interacts with Automated Link (10) to Short Security Database (11).
Y. System Algorithms (12) causes Securities Sold Short (14) either through its own programming, through a Report to Interested Parties for Confirmation (16), or through other means.
Z. Short Security Hold Placed (13) confirms to System Algorithm (12) that such hold is in place and System Algorithm (12) may proceed with operation.

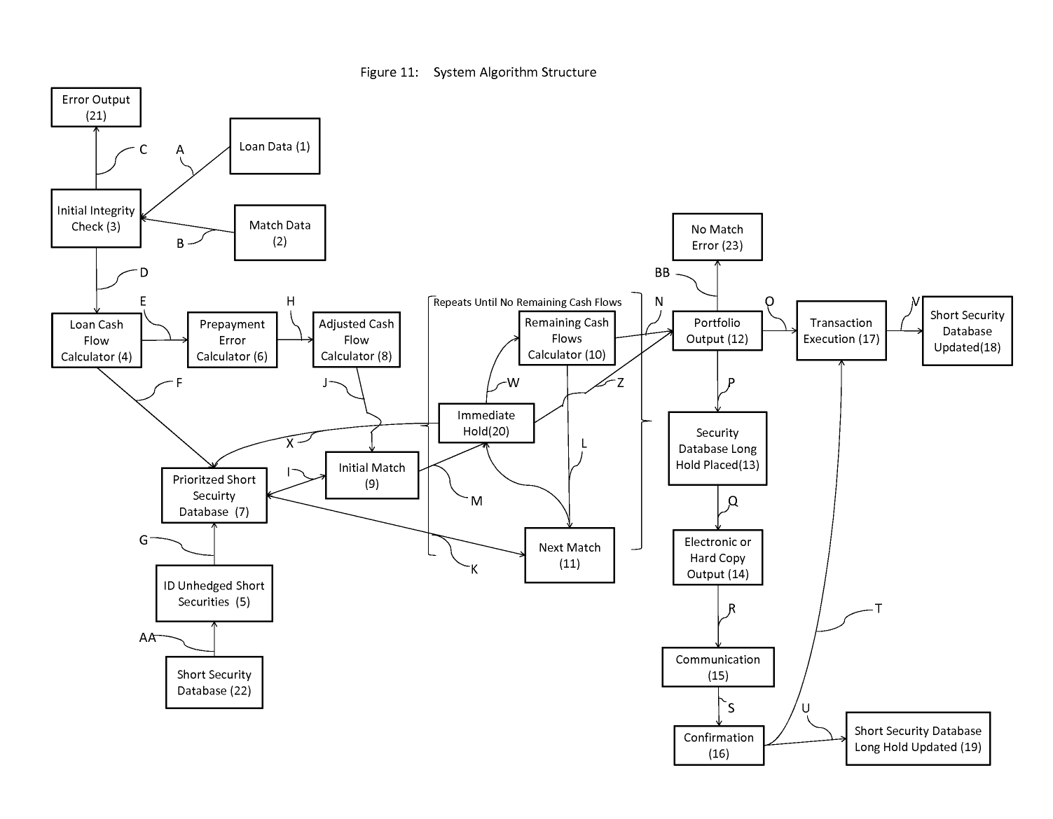

### FIG. 11 (System Algorithm Structure)

FIG. 11 shows a detailed view of the system algorithm components of the invention. After Loan Data and Match Data is entered the invention runs and Integrity Check to ensure that Data entered conforms to system parameters. If Data entered does not conform to system parameters, then an error output is registered. Data is then fed to the Loan Cash Flow Calculator, which develops a series of potential cash flows associated with the loan. The Loan Cash Flow Calculator makes assumptions, as to items such as interest rate, and refines those assumptions as the invention is run for multiple iterations. Separately, a Short Security Database is examined for Unhedged Short Securities. These Unhedged Short Securities which have previously been shorted and (for various reasons) are no longer matched to incoming cash flows from a loan. Alternatively, a Long Hold may have previously been placed on securities and the potential loan underlying the Long Hold is not anticipated to be made. The result of this input and the input of the Loan Cash Flow Calculator is the Prioritized Short Security Database. Each operation of the invention can result in a different priority of securities from a Short Security Database resulting in a different Prioritized Short Security Database for each operation of the invention.

The Prepayment Error Calculator uses information from the Loan Cash Flow Calculator to modify said cash flows to reflect real world payment habits and accounts for items such as probability and timing of prepayments, late payments, defaults, etc. The results are then fed to the Adjusted Cash Flow Calculator. These cash flows and the Prioritized Short Security Database are then used to arrive at an Initial Match of a security to short whose cash outflows from the Security Borrower can be offset by cash inflows from a Loan Borrower. The security identified is placed on Immediate Hold and the Remaining Cash Flows Calculator determines a new set of cash flows for a potential loan based on the Adjusted Cash Flows less cash flows matched during the Initial Match. The Remaining Cash Flows are then communicated to the Next Match. The Next Match uses the Remaining Cash Flows data and the Prioritized Short Security Database to make another match in similar fashion to the existing match. This matching process is repeated until either: (1) all cash flows are matched, (2) cash flows are matched to within system parameters, or (3) if securities are unavailable to make a suitable match according to system parameters, then an error message is displayed. The Portfolio Output has two other courses of action. First, it sends proceeds automatically to Transaction Execution which results in securities being borrowed and sold into a market and the consequent Updating of the Short Security Database. Alternatively, a Long Hold may be placed and a manual confirmation may be requested using Electronic or Hard Copy Output and Communication of that output to interested parties such as the Short Loan Lender and Loan Borrower. Positive Confirmation leads to Transaction Execution. Negative Confirmation results in the Short Security Database Long Hold being updated to reflect non-execution of a Transaction.

### Definitions for FIG. 11 (Numbers Relate to Those Found in the Figure):

1. Loan Data—Individual items of data are manually or automatically input. Items may include, but are not limited to, credit score, demographic information, appraisal information, previous/existing loan details, collateral information, asset information, income information, loan amount, loan duration, maturity, interest mode (mixed, fixed, variable), maturity schedule, payment information, etc.
2. Match Data—Information regarding the qualities of the match such as maturity match type (face value, market value, combination, other continuum), credit risk tolerance, types of securities to be shorted, cash flow match tolerance, etc, which are manually or automatically input.
3. Initial Integrity Check—System checks entered data for formatting or other input errors
4. Loan Cash Flow Calculations—Loan data is used to create a principal amortization schedule and approximate interest payments based on current and historical data. Multiple iterations of the system algorithm may be undertaken to refine a portfolio output.
5. ID Unhedged Short Securities—Short Security Database is examined for securities previously sold short that are no longer linked to an outstanding loan. This may occur due to early payoff of another loan, proactive shorting completed to take advantage of favorable market conditions, etc. May also be short security from long-hold that borrower elects not to consummate, so is still available to match to a loan.
6. Prepayment Error Calculator (optional)—Historical and projected early payoff error is determined. This is an approximation of the impact of an expected, but not required, potential early payoff of the loan
7. Prioritized Short Security Database—Short Security Database is sorted based on Unhedged Short Security Database (5) and other characteristics such as security borrowing terms, interest rate on available securities, minimum and maximum amounts of a security available etc. to allow a Short Loan Lender (FIG. 10, Definition 1) to prioritize Matching (FIG. 11, Definitions 9 and 11) securities that the Short Loan Lender (FIG. 10, Definition 1) as undesirable exposed risk to.
8. Adjusted Cash Flow Calculator—Updated Loan Cash Flow Calculated (4) to reflect adjustments made necessary by real world events including prepayments, defaults, etc.
9. Initial Match—Adjusted Cash Flow Calculator (8) are compared to available securities in the Prioritized Short Security Database (7) to make the initial principal payment match of the loan amortization to a security maturity.
10. Remaining Cash Flows Calculator—Adjusted Cash Flow Calculator (8) minus the cash flows of the security from the most recent Immediate Hold (20) from the Prioritized Short Security Database (7)
11. Next Match—Remaining Cash Flows Calculations (10) are compared to available securities in the Prioritized Short Security Database (7) to make the next principal payment match of the loan amortization to a security maturity.
12. Portfolio Output—The list of entries from the Prioritized Short Security Database (7) that have been matched to the total of the Adjusted Cash Flows Calculator (8) resulting in the absence of or tolerated amount of unmatched cash flows from the Remaining Cash Flows Calculator (10)
13. Security Database Long Hold Placed (optional)—Securities in the Prioritized Short Security Database (7) are placed on a long term hold (contemplated to be an amount of time greater than needed for execution of algorithms and short sale of securities (i.e. 30 days). A charge for a longer term hold analogous to buying a put option on securities is contemplated.
14. Electronic Hard Copy Output (optional)—Portfolio Output (12) along with information regarding the results of the match, including, but not limited to, unmatched Remaining Cash Flows (10), interest rate(s) of Portfolio Output (12), match errors, match tolerances, etc.
15. Communication (optional)—Transmittance of the Electronic Hard Copy Output (14) to Lenders, Borrowers, System Administrators, Regulators, or other interested parties.
16. Confirmation—The affirmation of the desire to execute a transaction described in the Electronic Hard Copy Output (14) under the proposed terms.
17. Transaction Execution—Portfolio Output (12) securities are borrowed from their owners and sold into a market.
18. Short Security Database Updated—Short Security Database (22) is updated to reflect the release of all Holds (definitions 20 and 13) related to Portfolio Securities (12) and Portfolio Security entries are updated to reflect unavailability of securities for further Matching (definitions 9 and 11) because they have been sold short in the current transaction.
19. Short Security Database Long Hold Updated—The release or redesignation of a Security Database Long Term Hold (13) from a particular Portfolio Output (12) caused by the non-affirmation of the desire to complete a transaction within a specified period of time or failure to adhere to the terms required to execute a transaction. Such Security Database Long Term Hold (13) modification may result in the Security Database Long Term Hold (13) being completely released or modified such that the terms of the Security Database Long Term Hold (13) are preserved until the originally contemplated end date to allow the Security Database Long Term Hold (13) or its underlying securities from the Unhedged Short Security Database (5) to be used in a subsequent Portfolio Output (12).
20. Immediate Hold—Security in Prioritized Short Security Database (7) is marked for borrowing and subsequent or concurrent sale. Period of hold is short. No longer than the time required to complete the algorithms and sale of securities from Sorted Short Security Database (7). For instance, less than 1 business day. One purpose is to prevent multiple loan matches being run simultaneously from reserving and potentially selling short the same security or portion thereof.
21. Error Output—Return of message to user that data entry errors are present and system cannot continue until corrected.
22. Short Security Database—A database consisting of a repository of information provided by client institutions, licensees, customers, or other entities that are part of the system whose primary purpose is to catalog Securities available to be borrowed for the purpose of initiating a Short Position. Data collected and displayed includes, but is not limited to, amount of security available, CUSIP number of security, other identifying information of security, terms of lending security (such as premium required or duration of loan).
23. No Match Error—The resulting output of an unsuccessful Portfolio Output match. Usually caused by unavailability of a set of securities whose cash flows match those of a prospective loan to within the system's tolerance. The “No Match Error” may potentially be corrected by changing match parameters.

### Interaction Between Elements of the FIG. 11 (Letters Relate to Those Found in the Figure):

A. Loan Data (1) is entered into the Initial Integrity Check (3)
B. Match Data (2) is entered into the Initial Integrity Check (3)
C. Initial Integrity Check (3) provides an Error Output (21) based on entered data.
D. Initial Integrity Check (3) provides checked data to the Loan Cash Flow Calculator (4)
E. Loan Cash Flow Calculator (4) provides data to the Early Payoff Calculator (6)
F. Loan Cash Flow Calculator (4) provides data to the Prioritized Short Security Database (7) for prioritizing securities in such database
G. ID Unhedged Short Securities (5) provides data to the Prioritized Short Securities Database (7) for purposes of sorting such database in anticipation of an Initial Match (9)
H. Early Payoff Error Calculator (6) provides data to the Adjusted Cash Flow Calculator (8)
I. Initial Match (9) queries Prioritized Short Security Database (7) and Prioritized Short Security Database (7) provides securities information to the Initial Match (9) which corresponds to securities that match the desired characteristics of the Adjusted Cash Flow Calculator (8)
J. Adjusted Cash Flow Calculator (8) provides proposed loan cash flow information to the Initial Match (9) for matching purposes
K. Initial Match (9) asks for an Immediate Hold (20) on initially matched securities from the Prioritized Short Security Database (7) which corresponds to a subset of the output of the Adjusted Cash Flow Calculator (8).
L. Remaining Cash Flows Calculator (10) provides proposed loan cash flow information minus previously Matched (9) Adjusted Cash Flows (8) to Next Match (11)
M. Next Match (11) asks for an Immediate Hold (20) on subsequently matched securities from the Prioritized Short Security Database (7) which correspond to the output of the Remaining Cash Flow Calculator (10)
N. Remaining Cash Flows Calculator (10) provides proposed loan cash flow information to the Portfolio Output (12)
O. Portfolio Output (12) provides information on Immediate Hold (20) securities which make up a portion of the Portfolio Output (12) to Transaction Execution (17)
P. Portfolio Output (12) provides security data to the Security Database Long Hold Placed (13) resulting in a long term hold being placed on Matched (definitions 9 and 11) securities and the release of an Immediate Hold (20) on such securities.
Q. Security Database Long Hold Placed (13) provides information on hold terms and Portfolio Output (12) to an Electronic or Hard Copy Output (14)
R. Electronic or Hard Copy Output (14) interacts with users, machines, or other devices for Communication (15)
S. Communication (15) of information received leads to interactions and the Confirmation (16). The result of the Confirmation (16) can be negative or positive.
T. A positive Confirmation (16) signals for a Transaction Execution (17)
U. A negative Confirmation (16) signals for a Short Security Database Long Hold Updated (19) resulting in the modification of the Security Database Long Hold Placed (13) and the returned availability of securities in the Short Security Database (Definitions 22) for subsequent Matching (Definitions 9 or 11) in subsequent operations of the invention.
V. Transaction Execution (17) results in Short Security Database Updated (18) to reflect the Transaction Execution (17) and changes to the Short Security Database (22) in subsequent operations of the invention.
W. Immediate Hold (20) provides Matched Security (definitions 9 and 11) from the Prioritized Short Security Database (7) to Remaining Cash Flows Calculator (10) to allow their corresponding cash flow subtraction from subsequent Next Match (11) iterations in regards to the present operation of the invention.
X. Immediate Hold (20) modifies Prioritized Short Security Database (7) to reflect tentative unavailability of Initial Match (9) or Next Match (11) securities for further Next Match (11) iterations or concurrent or subsequent operations of the invention during the period the Immediate Hold (20) is in place.
Y. Next Match (11) queries Prioritized Security Database (7) and Prioritized Short Security Database (7) provides securities information to the Next Match (11) which corresponds to securities that match the desired characteristics of the output of the Remaining Cash Flow Calculator (10) Z. Immediate Hold (20) conveys information on the security in Immediate Hold (20) to begin or continue building Portfolio Output (12).
AA. Short Security Database (22) provides information to ID Unhedged Short Securities (5) which results in the initial examination of securities contained therein.
BB. Portfolio Output (12) provides information to the No Match Error (23) to allow the No Match Error (23) to display information such as the error, potential methods to correct the error, and/or alternatives to eliminate the error.

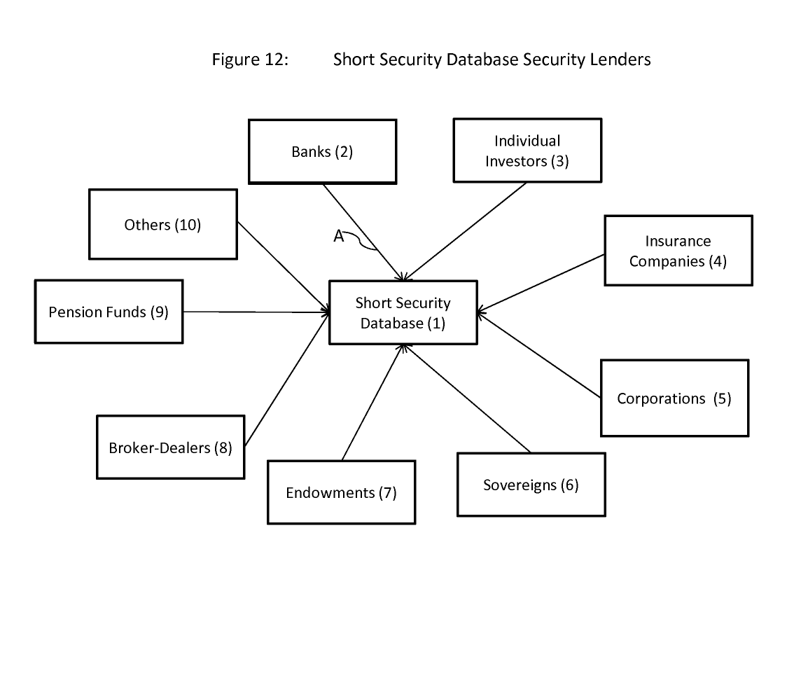

### FIG. 12 (Short Security Database Security Lenders)

FIG. 12 shows the various contributors of securities to the Short Security Database. These entities become Security Lenders when securities they make available through the Short Security Database are borrowed as part of a Short Loan. Participants include, but are not limited to Banks, Individual Investors, Insurance Companies, Corporations, Sovereigns, Endowments, Broker-Dealers, Pension Funds, and Others.

### Definitions for FIG. 12 (Numbers Relate to Those Found in the Figure):

1. Short Security Database—A database consisting of a repository of information provided by client institutions, licensees, customers, or other entities that are part of the system whose primary purpose is to catalog Securities available to be borrowed for the purpose of initiating a Short Position. Data collected and displayed includes, but is not limited to, amount of security available, CUSIP number of security, other identifying information of security, terms of lending security (such as premium required or duration of loan).
2. Banks—Financial institutions whose primary business is the taking of deposits and making of loans. Also includes other variants such as credit unions, thrifts, etc. Most banks keep excess capital in various securities investments that can be lent.
3. Individual Investors—Persons or entities that hold investments in their own name and have the ability to lend those investments.
4. Insurance Companies—Financial institutions whose primary business is pooling various types of risks across populations and charging members of that population for the risk sharing privilege. Most insurance companies keep a large amount of their reserves in the form of fixed income securities that may be lent.
5. Corporations—Entities engaged in businesses whose primary purpose is something besides making loans, but that generate cash flow and retained earnings that are kept at the entity level. Such retained earnings in the form of cash and equivalents are often kept in US Treasury securities that could be lent.
6. Sovereigns—National (such as a country, i.e. Germany) or sub-national (such as one of the United States, i.e. Ohio) ruling entities or persons who manage accounts and keep investments for foreign exchange reserves, tax receipts, etc that are invested in securities that may be lent.
7. Endowments—Mostly not-for-profit entities with a charitable or operational purpose that maintain reserves in securities that can be lent.
8. Broker-Dealers—Entities that custody investments and engage in other business on behalf of clients. Clients may maintain margin agreements that allow their securities to be lent or the Broker-Dealer may lend securities from its own accounts.
9. Pension Funds—Public or private entities whose purpose is to provide retirement income for its members. They maintain investment portfolios of securities that can be lent.
10. Others—Other people or entities not otherwise described who own securities that can be lent.

### Interaction Between Elements of the FIG. 12 (Letters Relate to Those Found in the Figure):

A. Person or Entity described makes securities available to lend through the Short Security Database.

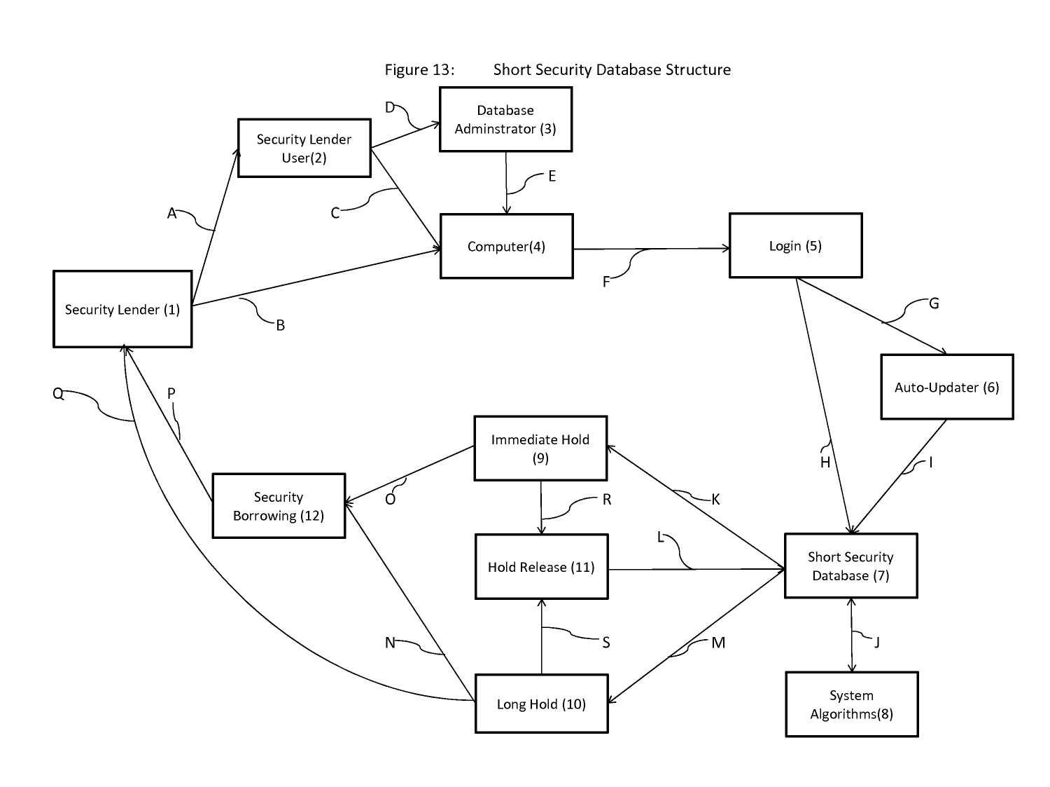

### FIG. 13 (Short Security Database Structure)

FIG. 13 shows a detailed view of the short securities database component of the invention. A Security Lender, who has securities available to lend uses, communicates with a Database Administrator or directly with a computer system. Alternatively the Security Lender may be able to communicate with a computer system without other intervention. That Computer system uses credentials supplied by its users to Login to the Computer system. From there, an Auto-Updating algorithm or a manual update to the Short Security Database may occur. The Short Security Database interacts with System Algorithms with the potential for an Immediate or Long Hold being placed on securities contained within the Short Security Database. A Long Hold also informs the Security Lender of the Long Hold and its consequences. An Immediate Hold leads to either Security Borrowing and an Immediate Hold release or an Immediate Hold release without Security Borrowing. Similarly, a Long Hold may lead to Security Borrowing and Long Hold Release or a Long Hold Release may occur without Security Borrowing. When any hold is released the Short Security Database is updated to reflect said Hold Release. Security Borrowing or a Long Hold Release results in communication of said information to the Security Lender.

### Definitions for FIG. 13 (Numbers Relate to Those Found in the Figure):

1. Security Lender—A person/entity with the ability to loan securities/assets.
2. Security Lender User—Representative of Security Lender (1).
3. Database Administrator—Administrator charged with making modifications to a database and is usually an employee or contractor of the database owner.
4. Computer—A device that allows interaction with programs and algorithms over a distance or locally in an electronic format. May also include smart phones, tablets, or other devices capable of operating programs based on algorithms.
5. Login—Gaining access to the data contents and processing capabilities of a Computer or Network.
6. Auto-Updater—Utilizes a computer and/or network connection to participants or owners of securities that are included in the Short Security Database (7) that allows the owners of those securities to automatically update security availability, including, but not limited to, making new securities available, withdrawing security availability, making changes to the amount of each security available, changing the terms of borrowing securities available, within the Short Security Database (7) based on programming entered by the Security Lender (1) or Database Administrator (3) among others.
7. Short Security Database—A database consisting of a repository of information provided by client institutions, licensees, customers, or other entities that are part of the system whose primary purpose is to catalog Securities available to be borrowed for the purpose of initiating a Short Position. Data collected and displayed includes, but is not limited to, amount of security available, CUSIP number of security, other indentifying information of security, terms of lending security (such as premium required or duration of loan).
8. System Algorithms—Software or other automated system that attempts to match loan data and Short Security Database (7) information for the purpose of structuring a loan and short position. See FIG. 11 for more detailed description of system Algorithms.
9. Immediate Hold—Security in Short Security Database (7) is marked for borrowing and subsequent or concurrent sale. Period of hold is short. No longer than the time required to complete the algorithms and sale of securities from Short Security Database (7). For instance, less than 1 business day. One purpose is to prevent multiple loan matches being run simultaneously from reserving and potentially selling short the same security or portion thereof.
10. Long Hold—Securities in the Short Security Database (7) are placed on a long term hold (contemplated to be an amount of time greater than needed for execution of algorithms and short sale of securities (i.e. 30 days). A charge for a longer term hold analogous to buying a put option on securities is contemplated.
11. Hold Release—An Immediate Hold (9) or Long Hold (10) is removed, freeing held securities from the Short Security Database (7) for unrestricted use within limits of the rules, regulations, and contracts of the Short Security Database (7)
12. Security Borrowing—A person or entity enters into a contract with a Security Lender (1) to borrow securities entered into the Short Security Database (7) under terms (standardized or negotiated) specified in the Short Security Database for the purpose of selling those borrowed securities in the market. Commonly referred to as “shorting” such borrowed securities. In return for lending securities Security Lender (1) is customarily, but not necessarily entitled to, payments in lieu to compensate for interest payments not received on lent securities, fees for borrowing securities, and/or an agreement on the prompt return of such securities or substantially identical securities under agreed upon circumstances.

### Interaction Between Elements of the FIG. 13 (Letters Relate to Those Found in the Figure):

A. Security Lender (1) appoints a Security Lender User (2) who may be an employee, contractor, or other designee and may be multiple people. Such person/people are given instructions to modify the Short Security Database (7).
B. Security Lender (1) has a direct link to a Computer (4).
C. Security Lender User (2) gains access to a Computer (4).
D. Security Lender User (2) communicates with a Database Administrator (3) who is responsible for modifying the Short Security Database (7).
E. Database Administrator (3) gains access to a Computer (4).
F. In any instance a User (including definitions 1, 2, and 3) of a Computer (4) uses credentials to Login (5) to the Short Security Database (7) interactive system.
G. A User (including definitions 1, 2, 3) uses an Auto-Updater (6) program with the intent to make modifications to the Short Security Database (7).
H. A User (including definitions 1, 2, 3) manually makes changes to the Short Security Database (7).
I. Auto-Updater (6) makes changes to the Short Security Database (7) based on Auto-Updater (6) software settings and information provided by Security Lender (1).
J. Short Security Database (7) interacts with System Algorithms as detailed in FIG. 11.
K. Short Security Database (7) places Immediate Hold (9) on securities contained in Short Security Database (7) based on System Algorithms as detailed in FIG. 11.
L. Hold Release (11) modifies Short Security Database (7) to reflect removal on restrictions caused by Immediate or Long Hold (definitions 9, 11).
M. Short Security Database (7) places Long Hold (10) when necessary based on System Algorithms as detailed in FIG. 11.
N. Long Hold (10) is resolved triggering Security Borrowing (12) for the purpose of selling borrowed securities that were identified in the Short Security Database (7).
O. Immediate Hold (9) is resolved triggering Security Borrowing (12) for the purpose of selling borrowed securities that were identified in the Short Security Database (7).
P. Notice of Security Borrowing (12) is served to Security Lender (1) for accounting, regulatory, and other purposes. Payment of premium may accompany Notice of Security Borrowing (12).
Q. Notice of Long Hold (10) is served to Security Lender (1) for accounting, regulatory, and other purposes. The Long Hold (10) may be accompanied by a payment for securing the Long Hold (10).
R. Immediate Hold (9) may result in a Hold Release (11) in the circumstance of an incomplete or complete iteration of the invention. An Immediate Hold (9) transmits information to Hold Release (11) for the purpose of modifying the Short Security Database (7).
S. Long Hold (10) may result in a Hold Release (11) when the Long Hold (10) expires, is canceled, or after securities secured by a Long Hold (10) are successfully borrowed. A Long Hold (10) transmits information to Hold Release (11) for the purpose of modifying the Short Security Database (7).

Among other things, it is an object of the present invention to provide lending/borrowing utilizing the difference between the yield on treasuries (or other yield baring assets) to be sold short and a market rate cost of capital that does not suffer from any of the problems or deficiencies associated with prior solutions.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings. Thus, it is intended that the present invention cover modifications and variations that come within the scope of the spirit of the invention and the claims that follow.

We claim that:

1. A method of aggregating securities comprising:
A processing system;
Building a portfolio of securities to sell short;
Using proceeds from said short sale to make a loan;
Holding, divesting, or disposing of assets and risks associated with said loan.

2. The method of claim 1 wherein the processing system includes an input device capable of receiving desired loan data including principal amount, maturity date, amortization schedule, variable rate period, fixed rate period, loan draw schedule, collateral position.

3. The method of claim 1 wherein the processing system includes an input device capable of receiving available security data such as type of security, interest rate, maturity, CUSIP or other identifying characteristic, amortization, amount of security available, terms of borrowing available security, hold status, borrowed status, loan to which borrowed security is assigned.

4. The method of claim 1 wherein the processing system includes a memory having a database storing data related to the desired loan.

5. The method of claim 1 wherein the processing system includes a memory having a database storing data related to securities available to short and to securities that have been sold short as part of this system.

6. The method of claim 1 wherein the processing system includes calculation of cash flow stream generated by the loan.

7. The method of claim 1 wherein the processing system includes calculation of adjusted cash flows which takes into consideration empirical data on prepayment and missed payment behavior of other borrowers.

8. The method of claim 1 wherein the processing system includes calculation of the cash flows of securities available to sell short.

9. The method of claim 1 wherein the processing system includes production of a portfolio of securities to sell short whose proceeds may be used to make a loan.

10. The method of claim 1 wherein the processing system includes providing information relating to the portfolio of securities to sell short whose cash flows and maturities match within an accepted tolerance the cash flows and maturities of a loan to be made with the proceeds of selling securities short.

11. The method of claim 1 wherein the processing system includes the ability to match maturities of a loan based on face value, market value, or a combination of face value and market value, or point on a continuum between face and market values of securities to sell short.

12. The method of claim 1 further comprising:
a comparison circuit which compares the partial or complete cash flows of the loan to be made to the partial or complete cash flows of securities available to short from a security database to determine the initial portfolio security from a short security database.

13. The method of claim 1 wherein the system includes an output which modifies a short security database to reserve the identified security for further action.

14. The method of claim 1 wherein the system includes a calculation circuit which calculates the cash flows of a loan to be made from the proceeds of selling securities short or remaining cash flows of said loan after one or more previous aggregations of cash flows have been subtracted.

15. The method of claim 1 wherein the system includes an output which communicates to the user the failure to identify a security to short.

16. The system of claim 1 further comprising:
a comparison circuit which compares the remaining cash flows of the loan to be made from the proceeds of selling securities short to the cash flows of securities available to short.

17. The method of claim 1 wherein the system includes an output which modifies a short security database that reserves the identified security for further action.

18. The method of claim 1 wherein the system includes an output which communicates to the user the failure to identify a security to short whose cash flows match within specified tolerances the cash flows of a loan to be made.

19. The method of claim 1 wherein the system includes:
an iteration circuit which repeats the steps of the system of claim 16 until a portfolio of securities to sell short to fund a loan is complete.

20. The method of claim 1 wherein the system includes:
a storage circuit having a record file for data relating to the loan to be made;
a storage circuit having a record file for the securities identified to be included in the short security portfolio.

21. The method of claim 1 wherein the system includes an output device.

22. The method of claim 1 wherein the system includes display of the system output on a display screen.

23. The method of claim 1 wherein the system includes disseminates system output using a communication network.

24. The method of claim 1 wherein the system includes using an output to execute transactions to sell securities short.

25. The method of claim 24 wherein a security database is modified to reflect the confirmation of executed transaction(s) to sell securities short.

26. The method of claim 1 wherein the system includes an output that results in a user having an option to reserve securities identified in a security database for a specified period of time.

27. The method of claim 26 wherein the user has the option to select the period of time for which to reserve securities from a security database.

28. The method of claim 1 wherein the proceeds of selling securities short are used to make a loan to a borrower.

29. The method of claim 28 where a loan to a borrower is aggregated with other loans to borrowers.

30. The method of claim 1 wherein the terms of borrowing securities available to sell short are established by in an auction by the underlying owners of a security available to be borrowed for the purpose of selling it short.

31. The method of claim 30 where the owner of a security can make that security available to short by bidding on a minimum fee to be received in exchange for borrowing said owner's security.

32. The method of claim 1 wherein the lender of a loan made from the proceeds of a portfolio of securities sold short divests all or partial risk for gains or losses created through the market price movement of securities sold short to fund said loan to the borrower of said loan or to a third party.
